(19) United States
(12) Patent Application Publication
(10) Pub. No.: US 2025/0014358 A1
(43) Pub. Date: Jan. 9, 2025

(54) METHOD AND DEVICE FOR IMAGE PROCESSING, STORAGE MEDIUM

(71) Applicants: SENSETIME GROUP LIMITED, Hong Kong (CN); HONDA MOTOR CO., LTD., Tokyo (JP)

(72) Inventors: Xiaohan WANG, Hong Kong (CN); Peiwen LIN, Hong Kong (CN); Kaname TOMITE, Hong Kong (CN)

(21) Appl. No.: 18/892,674

(22) Filed: Sep. 23, 2024

Related U.S. Application Data
(63) Continuation of application No. PCT/CN2022/129070, filed on Nov. 1, 2022.

(30) Foreign Application Priority Data
Mar. 24, 2022 (CN) 202210301591.0

(51) Int. Cl. G06V 20/58; G06V 10/25; G06V 10/74; G06V 10/764; G06V 10/77

(52) U.S. Cl. CPC G06V 20/582; G06V 10/25; G06V 10/761; G06V 10/764; G06V 10/7715

(57) ABSTRACT

A method and device for image processing, and a storage medium are provided. The method includes the following operations. A video stream captured by an image capturing device installed on a traveling device is acquired, and a plurality of frames of image containing a specific traffic object are determined from the video stream. A category of a specific traffic object and a confidence level of the category in each of the plurality of frames of image are determined. Correction information of the category, the confidence level of which does not meet a preset condition, is determined based on a comparison result of the confidence levels of the categories of the specific traffic object in the plurality of frames of image.

### CROSS-REFERENCE TO RELATED APPLICATIONS

This application is a continuation application of International Patent Application No. PCT/CN2022/129070, filed on Nov. 1, 2022, which claims the Chinese patent application No. 202210301591.0, filed on Mar. 24, 2022, and titled “IMAGE PROCESSING METHOD AND APPARATUS, ELECTRONIC DEVICE, AND STORAGE MEDIUM”. The entire content of International Patent Application No. PCT/CN2022/129070 and Chinese patent application No. 202210301591.0 is hereby incorporated into this application by reference.

### BACKGROUND

In the related art, traffic objects (such as traffic signs) can be classified and recognized by a multi-class task model. However, because there are many traffic objects and recognition for the traffic objects are easily affected by long distance or object occlusion, the recognition accuracy is not high.

### SUMMARY

The present disclosure relates to, but is not limited to, the technical field of image processing, and particularly relates to a method and device for image processing, and a non-transitory computer-readable storage medium.

The technical solution of the embodiments of the present disclosure is realized as follows.

A first aspect of the embodiments of the present disclosure provides a method for image processing, and the method includes the following operations.

A video stream captured by an image capturing device installed on a traveling device is acquired, and a plurality of frames of image containing a specific traffic object are determined from the video stream.

A category of a specific traffic object and a confidence level of the category in each of the plurality of frames of image are determined.

Correction information of the category, the confidence level of which does not meet a preset condition, is determined based on a comparison result of the confidence levels of the categories of the specific traffic object in the plurality of frames of image.

A second aspect of the embodiments of the present disclosure further provides a device for image processing, and the device includes: a memory; a processor; and a computer program stored on the memory and executable on the processor.

The processor is configured to execute the computer program to: acquire a video stream captured by an image capturing device installed on a traveling device; determine a plurality of frames of image containing a specific traffic object from the video stream; determine a category of a specific traffic object and a confidence level of the category in each of the plurality of frames of image; and determine correction information of a category, the confidence level of which does not meet a preset condition, based on a comparison result of the confidence levels of the categories of the specific traffic object in the plurality of frames of image.

A third aspect of the embodiments of the present disclosure further provides a non-transitory computer-readable storage medium having stored thereon a computer program which, when executed by a processor, implements: acquiring a video stream captured by an image capturing device installed on a traveling device, and determining a plurality of frames of image containing a specific traffic object from the video stream; determining a category of the specific traffic object and a confidence level of the category in each frame of the plurality of frames of image; and determining correction information of the category, the confidence level of which does not meet a preset condition, based on a comparison result of the confidence levels of the categories of the specific traffic object in the plurality of frames of image.

### BRIEF DESCRIPTION OF THE DRAWINGS

FIG. 1 is a schematic diagram of an application scenario of a method for image processing according to an embodiment of the present disclosure.

FIG. 2 is a schematic flow diagram of a method for image processing according to an embodiment of the present disclosure.

FIG. 3 is a schematic diagram of a classification result in a method for image processing according to an embodiment of the present disclosure.

FIG. 4 is a schematic diagram of reliability of classification results in a method for image processing according to an embodiment of the present disclosure.

FIG. 5 is a schematic diagram of a composition structure of a device for image processing according to an embodiment of the present disclosure.

FIG. 6 is a schematic diagram of a hardware composition structure of an electronic device according to an embodiment of the present disclosure.

### DETAILED DESCRIPTION

The embodiments of the present disclosure will be described in further detail below with reference to the accompanying drawings and specific embodiments.

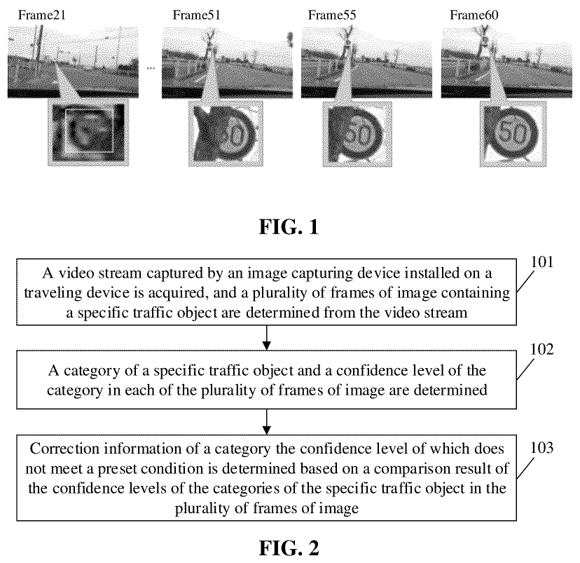

In the related art, traffic objects are mostly recognized by a single-layer multi-class classifier. Because there are many categories of traffic objects, the traffic objects are difficult to be labeled and classified accurately due to long distance and object occlusion or the like. FIG. 1 is a schematic diagram of an application scenario of a method for image processing according to an embodiment of the present disclosure. As shown in FIG. 1, contents of a traffic sign in the 21 st frame (Frame21) of image cannot be recognized due to the long distance. A traffic sign in the 51st frame (Frame51) of image is easily recognized as a speed limit of 30 due to occlusion of a tree trunk. The traffic sign in the 55th frame (Frame55) of image is easily recognized as a speed limit of 60 due to occlusion of the tree trunk. Finally, the traffic sign in the 60th frame (Frame60) of image can be correctly regarded as the speed limit of 50.

In the embodiment of the present disclosure, the electronic device corrects the category, confidence level of which does not meet the preset condition, according to the comparison result of the confidence levels of the categories of the specific traffic object in a plurality of frames of image. That is, the classification result with low reliability of the specific traffic object is corrected by using the classification result with high reliability of the specific traffic object, which can improve the classification accuracy of the traffic object in the image on the one hand, and can provide a reliable basis for downstream decision control on the other hand.

In various embodiments of the present disclosure, the traffic object may be an arbitrary object on a road, which may include, for example, at least one of a traffic sign, a road sign, a traffic participant, and a traffic light.

It should be noted that, in embodiments of the present disclosure, the terms “include”, “contain”, or any other variation thereof are intended to encompass a non-exclusive inclusion such that a method or device comprising a series of elements includes not only the elements explicitly recited but also other elements not explicitly listed, or the elements inherent to implement the method or device. Without any further limitation, an element defined by the statement “include a . . . ” does not preclude the presence of additional related elements (e.g., operations in a method or units in a device, e.g., units may be a partial circuitry, partial processor, partial program or software, etc.) in a method or device comprising the element.

For example, the method for image processing provided by the embodiment of the present disclosure includes a series of operations, but the method for image processing provided by the embodiment of the present disclosure is not limited to the described operations, and similarly, the device for image processing provided by the embodiment of the present disclosure includes a series of modules, but the device provided by the embodiment of the present disclosure is not limited to include only the explicitly recited modules, and may also include modules required for acquiring relevant information or perform processing based on the information.

The term “and/or” used herein merely indicates an association relationship that describes associated objects, indicating three relationships. For example, A and/or B may indicate three cases where A exists alone, both A and B exist, and B exists alone. In addition, the term “at least one” used herein denotes any one of the plurality elements or any combination of at least two of the plurality of elements. For example, at least one of A, B or C may denote any one or more elements selected from the set consisting of A, B, and C.

The embodiments of the present disclosure provide a method for image processing. FIG. 2 is a schematic flow diagram of a method for image processing according to an embodiment of the present disclosure. As shown in FIG. 2, the method includes operations 101 to 103.

At 101, a video stream captured by an image capturing device installed on a traveling device is acquired, and a plurality of frames of image containing a specific traffic object is determined from the video stream.

At 102, a category of a specific traffic object and a confidence level of the category in each of the plurality of frames of image are determined.

At 103, correction information of the category, the confidence level of which does not meet a preset condition, is determined based on a comparison result of the confidence levels of the categories of the specific traffic object in the plurality of frames of image.

The method for image processing of the present embodiment is applied to an electronic device, and the electronic device may be a vehicle-mounted device, a cloud platform, or other computer device. Exemplarily, the vehicle-mounted device may be a thin client, a thick client, a microprocessor-based system, a mini-computer system, and the like installed on the traveling device, and the cloud platform may be a distributed cloud computing technology environment including a mini-computer system or a mainframe computer system, and the like. The traveling device may be, for example, various vehicles traveling on a road, and the following embodiments will be described by taking a vehicle as an example of the traveling device.

In the embodiment, the vehicle-mounted device may be communicatively connected to a sensor, a positioning device or the like of the vehicle, and the vehicle-mounted device may acquire data collected by the sensor of the vehicle, geographic location information reported by the positioning device, or the like through the communication connection. Exemplarily, the sensor of the vehicle may be at least one of a millimeter-wave radar, a Light Detection and Ranging (LiDAR), a camera and other device; and the positioning device may be a device for providing a positioning service based on at least one of the following positioning systems: a Global Positioning System (GPS), a Beidou satellite navigation system, or a Galileo satellite navigation system.

In one example, the vehicle-mounted device may be an Advanced Driving Assistant System (ADAS), the ADAS may be provided on the vehicle, the ADAS may acquire real-time position information of the vehicle from a positioning device of the vehicle, and/or the ADAS may acquire image data, radar data, or the like representing environment information around the vehicle from a sensor of the vehicle. Optionally, the ADAS may transmit vehicle traveling data including real-time position information of the vehicle to the cloud platform. In this way, the cloud platform may receive real-time position information of the vehicle and/or image data, radar data and the like representing environment information around the vehicle.

In the present embodiment, the video stream is obtained by an image acquisition device (that is, the above-described sensor, such as a camera) provided on the traveling device, and the image acquisition device acquires a road image or an environment image around the traveling device in real time as the traveling device moves, that is, the video stream may be continuous images obtained by continuously acquiring the surrounding environment or scenario by the traveling device in a traveling state.

In some alternative embodiments, the electronic device may identify each frame of images in the video stream through a classification network, determine that each frame of images includes a specific traffic object and a category of the specific traffic object. Exemplarily, the video stream is inputted to a classification network, and feature extraction is performed on each frame of image in the video stream through the classification network, a specific traffic object in the image is determined based on the extracted feature, and it is determined that the specific traffic object is in a first region of the image, and a category of the specific traffic object is determined. The category of the specific traffic object may be one category of a plurality of categories of traffic object. For example, traffic objects are classified into a plurality of categories in advance, and each category may include one or a plurality of traffic objects. The category of the specific traffic object may be one of the categories classified in advance.

In some optional embodiments, the operation that the confidence level of the category of the specific traffic object in each of the plurality of frames of image is determined may include: determining a template image of the category of the specific traffic object in each of the plurality of frames of image, calculating a similarity between the specific traffic object and the template image, and determining the confidence level of the category of the specific traffic object based on the similarity.

In the embodiment, the template images of all categories are stored in the electronic device. After determining the category of the specific traffic object, the electronic device compares the image of the first region where the specific traffic object is located with the template image of the category, and calculates a similarity between the specific traffic object and the template image of the category, and takes the calculated similarity as a confidence level of the category of the specific traffic object.

In the embodiment, the electronic device determines correction information of the category, the confidence level of which does not meet the preset condition, based on the comparison result of the confidence levels of the categories of the specific traffic object in the plurality of frames of image, and corrects the category the confidence level of which does not meet the preset condition. Exemplarily, the confidence level does not meet the preset condition may refer to that the confidence level is less than a preset threshold.

Optionally, the operation that the correction information of the category, the confidence level of which does not meet a preset condition, is determined based on a comparison result of the confidence levels of the categories of the specific traffic object in the plurality of frames of image includes setting a category of the specific traffic object in a second image in the plurality of frames of image to be the category of the specific traffic object in a first image in the plurality of frames of image, in a case that a confidence level of the category of the specific traffic object in the first image meets the preset condition and a confidence level of the category of the specific traffic object in the second image does not meet the preset condition. An order of the first image and the second image is not limited, that is, the first image is distributed after the second image, or the first image is distributed prior to the second image.

In the embodiment, the electronic device can correct a classification result of the specific traffic object with low reliability based on a classification result of the specific traffic object with high reliability, to correct the category the confidence level of which does not meet the preset condition, which can provide a sufficient basis for the downstream module (for example, the control module, the decision module, and the like), and facilitate subsequent real-time control.

In some optional embodiments of the present disclosure, the operation that the plurality of frames of image containing the specific traffic object are determined from the video stream includes: determining a first region where a traffic object is located in each of images containing the traffic object in the video stream; determining a second region within the first region for each first region, the second region being smaller than the first region; and selecting, based on information about each second region, an image containing a traffic object of a first category from the images containing the traffic object as the plurality of frames of image containing the specific traffic object. The first category is a category to which the specific traffic object belongs.

In the embodiment, the electronic device determines a first region where a traffic object is located in each frame of image in the video stream, that is, a detection frame (for example, a rectangular frame) of the traffic object in the image. A region of the detection frame in the image is the first region. The electronic device determines a second region within the first region in each image in the video stream.

Optionally, the second region is a central region of the first region, and the information about the second region is information of a central region of a feature map of the first region.

As an example, the second region may be determined by scaling down the length and the width of the first region (that is, the detection frame of the traffic object) at the same proportion. The scaled-down region is a second region, and the second region may also be referred to as a central region of the first region. As another example, the second region may be determined by scaling down the length and the width of the first region at different proportions according to a degree that the traffic object is blocked and moving a central point according to a blocked position of the traffic object. Taking the 51st frame of image or the 55th frame of the image in FIG. 1 as an example, it is found by detecting the traffic object that the left side of the traffic object is blocked, and the length and the width of the first region (that is, a detection frame of the traffic object) in which the traffic object is located can be scaled down in different proportions. Since the left side of the traffic object is blocked, the scaled-down region can be moved to the right (the moved region is also in the first region) to obtain the second region, so that features of the traffic object are reserved as much as possible in the second region to reduce features of occlusion.

In the embodiment, the electronic device selects out the image including a traffic object of a first category from the images including the traffic object based on information about the second region in the image, and sets a plurality of frames of image including the traffic object of the first category as a plurality of frames of image including a specific traffic object. The first category is a category to which the specific traffic object belongs.

In some optional embodiments, the operation that the image containing the traffic object of the first category is selected from the images containing the traffic object based on the information about each of the second regions includes: performing feature extraction on each of the second regions, and determining a first similarity of pixels in each of the second regions based on the extracted features; determining an image in which the second region in which position information meets a first preset condition and the first similarity meets a second preset condition is located as an image containing the traffic object of the first category. The first category is a category to which the specific traffic object belongs.

Optionally, the position information of the second region in the image including the traffic object meets the first preset condition may refer to that a distance between the position information about the second regions in any two adjacent frames of the image including the traffic object is less than a first threshold, that is, a difference between the positions of the second regions in the images in which the second regions are located is less than the first threshold. The distance may be a distance in a specified coordinate system (e.g., a pixel coordinate system, an image coordinate system, etc.).

Optionally, the first similarity meets a second preset condition may refer to that the first similarity is greater than or equal to a second threshold.

Exemplarily, for example, the image including the traffic object includes a first image and a second image, and the second image is one frame of image after the first image. In one example, the second image may be an image subsequent to the first image. In another example, the second image may be spaced by several frames after the first image. For example, in FIG. 1, the first image may be the 21st frame of image, and the second image may be the 51 st frame of image, the 55th frame of image, or the 60th frame of image.

The electronic device recognizes a traffic object in the first image and the second image respectively, and determines a first region of the traffic object in the first image and a first region of the traffic object in the second image. In this example, the recognized traffic object in the first image is tracked by using a second region smaller than the first region where the traffic object is located. The tracking is performed within the second region by considering that an occlusion usually blocks an edge of the traffic object, which is robust to occlusion.

For example, the length and width of the first region (that is, the detection frame) are scaled down in the same proportion, and the scaled-down region is taken as a second region, and the second region may also be referred to as a central region of the first region. In some embodiments, whether the traffic object in the first image and the second image is a traffic object of the first category may be determined based on a pixel point of the second region in the first image and a pixel point of the second region in the second image.

In some embodiments, feature extraction may be performed on a pixel of the second region in the first image, feature extraction may be performed on a pixel of the second region in the second image, and a similarity degree (herein, referred to as a first similarity degree) between the first image and the second image may be calculated based on the extracted features. When the first position information and the second position information meet a first preset condition and the first similarity meets a second preset condition, the traffic objects corresponding to the second region in the first image and the second image are determined to be in the first category. The first position information may be coordinates of a central point of a second region in the first image, and the second position information may be coordinates of a central point of a second region in the second image.

Optionally, the first position information and the second position information may meet a first preset condition in a case that a distance between the first position information and the second position information (for example, a distance between the coordinates of the central point of the second region in the first image and the coordinates of the central point of the second region in the second image) is less than a first threshold. The distance may be a distance in a specified coordinate system (e.g., a pixel coordinate system, an image coordinate system, etc.). For example, in a pixel coordinate system, a first central point coordinate corresponding to the first position information is determined, a second central point coordinate corresponding to the second position information is determined. A distance between the first position information and the second position information is determined by obtaining a difference between the first central point coordinate and the second central point coordinate. In practical application, because a frame interval of the acquired image is extremely small, if the traffic object of the first category is included in different frame images, positions of the traffic object in different frame images are also similar.

Optionally, the first similarity may meet the second preset condition in a case that the first similarity may be greater than or equal to a second threshold. When the first similarity is greater than or equal to a second threshold, it may be determined that the traffic object in the second region in the first image is in the same category as the traffic object in the second region in the second image, that is, the traffic objects are objects of the first category (but the traffic objects may not be the same traffic object). In combination with the first position information and the second position information meeting the first preset condition, it may be determined that the traffic object corresponding to the second region in the first image and the traffic object corresponding to the second region in the second image are the same traffic object.

In one case, feature extraction may be performed in the second region in each of the images, and a first similarity of pixels in the second regions in the images may be determined based on the extracted features. When the first similarity meets the second preset condition, it may be determined that the traffic objects in the images are of the same category (such as the first category). In this case, the traffic objects in the images may be considered to be of the same category (such as the first category), but may not be the same traffic object. In another case, on the basis of determining the first similarity, and in a case that the position information of the second region in each of the images meets the first preset condition, and the first similarity meets the second preset condition, it may be determined that the traffic objects in the images are of the same category (for example, the first category). In this case, the traffic objects in the images are considered to be of the same category (such as the first category) and are the same traffic object. That is, the traffic object of the first category described in the embodiment is not limited to the traffic objects of the same category in at least two frames of image, and may also include the same traffic object in at least two frames of image.

In implementation, the traffic objects in at least two frames of image are determined to be the same traffic object by the following manner. A unique identification (ID) may be assigned to the traffic object identified in each frame of images, so as to identify the same traffic object between different frames of image. In a case where the traffic objects in the plurality of frames of image are of the same category (such as a first category), a first ID is assigned to the traffic objects in the plurality of frames of image.

In the embodiment, in a case that the plurality of frames of image include the first image and the second image, after a traffic object in the first image (for example, denoted as object 1) is recognized, a first ID is assigned to the traffic object (object 1). When it is determined that the traffic object (for example, denoted as object 2) corresponding to the second region in the second image and the traffic object (object 1) corresponding to the second region in the first image belong to the same category (for example, the first category), the first ID assigned to the object 1 can be associated with the object 2, that is, both the object 1 and the object 2 are associated with the first ID as traffic objects of the same category (for example, the first category). Alternatively, the first ID is assigned to object 1 and a second ID is assigned to object 2. When it is determined that the object 1 and the object 2 belong to the same category (e.g., the first category), the first ID and the second ID are associated. For example, the second ID can be replaced with the first ID. That is, both the object 1 and the object 2 are associated with the first ID as traffic objects of the same category (e.g., the first category).

In some optional embodiments of the disclosure, the operation that the category of the specific traffic object and the confidence level of the category are determined in each of the plurality of frames of image includes: determining a fine classification category with the largest confidence level of a traffic object of the first category and a confidence level of the fine classification category in each of the plurality of frames of image. The first category is a category to which the specific traffic object belongs.

Accordingly, the operation that correction information of the category, the confidence level of which does not meet the preset condition, is determined based on the comparison result of the confidence levels of the categories of the specific traffic objects in the plurality of frames of image includes: determining correction information of a fine classification category of the traffic object of the first category, the largest confidence level of which does not meet the preset condition, based on a comparison result of the confidence levels of the fine classification categories with the largest confidence level of the traffic object of the first category in the plurality of frames of image.

In the embodiment, the electronic device firstly determines a first category of the traffic object (that is, a coarse classification category), and then determines a fine classification category of the traffic object in the first category. That is, the electronic device firstly performs coarse-granularity classification on the traffic object, and then performs fine-granularity classification on the traffic object in the coarse-granularity classification.

Alternatively, the electronic device may identify each frame of image in the video stream through a first layer network, and determine that all frames of image include a traffic object of the same category (first category). That is, the electronic device detects the traffic object in each frame of image, and determines that the detected traffic object belongs to the same category (that is, the first category). Exemplarily, the video stream can be used as input data of the first layer network, feature extraction is performed on each frame of image in the video stream through the first layer network, a traffic object in each frame of image is determined based on the extracted features, a first region of a traffic object in each frame of image is determined, and a category of the traffic object (such as coarse classification category) is determined, that is, a detection frame of the traffic object in each frame of image and a category (coarse classification category) to which the traffic object belong are outputted. Furthermore, a plurality of frames of image that include the traffic objects belonging to the same category (herein referred to as the first category) are determined therefrom. Optionally, the plurality of frames of image may be multiple frames of image continuous or discontinuous in a video stream. For example, the video stream includes 100 frames of image, and the plurality frames of image including the traffic object of the first category may be the 10th to 50th frames of image, or may be the 5th frame, the 15th frame, the 25th frame, the 35th frame, the 45th frame, or the like of image among the 100 frames of image, which is not limited in the present embodiment.

In some optional embodiments, the category (including the first category) to which the specific traffic object belongs is one category of a plurality of categories of traffic objects. It can be understood that the first layer network is obtained by pre-training based on the traffic object classification, and whether the traffic object in the image belongs to the pre-labeled category of the traffic object and to which category of the traffic object in the image belongs may be determined by processing the image through the first layer network.

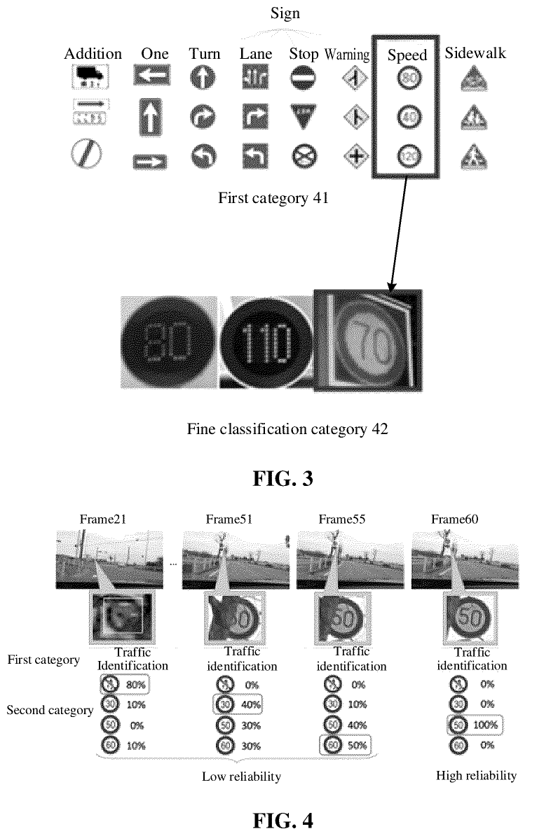

Exemplarily, in a case that the traffic object is a traffic identification (including, for example, a traffic sign and a road sign), various traffic identifications are classified in advance in this embodiment since there are many categories of traffic identifications. For example, as shown in FIG. 3, traffic identifications may be classified into a plurality of first categories 41 in advance, such as speed signs, sidewalk signs, warning signs, stop signs, and the like. It is assumed that the traffic object in each frame of image in the video stream is identified, the plurality frames of image containing the objects in the category of “speed identification” can be selected out. In practical application, the traffic identification may be classified according to a function or effect of the traffic identification. In other embodiments, other classification methods may also be adopted, which is not limited in the embodiment.

In some embodiments, after a plurality of frames of image including traffic objects of the same category (i.e., the first category) are determined by the first layer network, the traffic object of the first category in each of the plurality of frames of image is fine-classified by the second layer network, to obtain a fine classification category of the traffic object of the first category in each frame of images and a confidence level of the fine classification category.

In the embodiment, the second layer network may be a classification network [0063] corresponding to a category to which the traffic object belongs. Alternatively, the number of the second layer networks may correspond to the number of categories to which the traffic object belongs, that is, a category to which each traffic object belongs may correspond to a second layer network, and each second layer network is marked with a fine classification category in the category to which the traffic object belongs in advance. Taking a speed identification shown in FIG. 3 as an example, a plurality of fine classification categories 42 are included for the speed identification, such as a speed identification of 80 kilometers per hour (km/h), a speed identification of 40 km/h, a speed identification of 120 km/h, a speed identification of 70 km/h, and the like. After the traffic object is determined to be a speed identification, a fine classification category with the largest confidence level of the traffic object and the confidence level of the fine classification category can be obtained through classification processing of the second layer network. For example, the fine classification category with the largest confidence level of the traffic object may be a speed identification of 70 km/h.

In other embodiments, the second layer network may also correspond to a category to which a plurality of traffic objects belong. Taking a traffic identification as an example, the second layer network can be used to identify the fine classification categories of “one-way sign”, “turn sign” and “lane sign”. Alternatively, the second layer network may include a plurality of branch networks for classification processing, and each branch network may be used to identify fine classification categories corresponding to one or more categories to which traffic objects of the one or more categories belong. Exemplarily, after a category (such as a first category) to which the traffic object belongs is recognized by the electronic device, the electronic device cuts a sub-image corresponding to a first region where the traffic object is located, and inputs the sub-image to a branch network corresponding to the first category for identifying a fine classification category of the first category.

In this way, the first category (coarse classification category) of the traffic object is determined, and then a fine classification category of the traffic object in the first category is determined. That is, coarse-granularity classification is performed on the traffic object, and fine-granularity classification is performed on the traffic object in the coarse granularity classification, thereby improving the classification accuracy of the traffic objects (such as traffic signs, road signs, etc.) in the image. Especially in the case that traffic objects of multiple categories are recognized by a single-layer multi-classifier at present, the problem that it is difficult to label and accurately classify the traffic objects due to multiple categories can be improved.

In some optional embodiments of the present disclosure, the operation that the fine classification category with the largest confidence level of the traffic object of the first category and the confidence level of the fine classification category in each of the plurality of frames of image includes: determining a second similarity between a traffic object of the first category and a template image of each of second categories in each of the plurality of frames of image, each of the second category being a fine classification category of the first category; determining a fine classification category with the largest confidence level of the traffic object of the first category and a confidence level of the fine classification category in each frame of the image based on the second similarity.

In the embodiment, the template images of the second categories are stored in the electronic device. After determining the first category of the traffic object, the electronic device compares the image (which may be a feature map of a region where the traffic object is located) with the template image of each of the respective second categories, and determines a similarity (herein, referred to as a second similarity) between the traffic object of the first category and the template image of each of the respective second categories in each frame of the image. The largest second similarity can also be used as the confidence level of the fine classification category (e.g., the second category) of the traffic object, or the confidence level of the fine classification category (e.g., the second category) of the traffic object may also be calculated based on the largest second similarity.

Exemplarily, as shown in FIG. 4, the traffic object in the 60th frame (Frame60) of image is compared with the template image of each of the second categories, and the second similarity between the traffic object in the 60th frame of image and the speed identification “50 km/h” is determined to be 100%. The traffic object in the 55th frame (Frame55) of image is compared with the template image of each of the second categories, and the second similarity between the traffic object in the 55th frame of image and the speed identification “60 km/h” is determined to be 50%. The traffic object in the 51st frame (Frame51) of image is compared with the template image of each of the second categories, and the second similarity between the traffic object in the 51st frame of image and the speed identification “30 km/h” is determined to be 40%. The traffic object in the 21st frame (Frame21) of image is compared with the template image of each of the second categories, and the second similarity between the traffic object in the 21st frame of image and the “No U-turn sign” is determined to be 80%. The fine classification category with the largest confidence level and the confidence level of the fine classification category are determined from all the second similarities. In the above example, the largest confidence level is 100%, and the corresponding fine classification category is speed identification “50 km/h”.

Exemplarily, in a case where a largest confidence level of the second category to which the traffic object belongs in the plurality of frames of image is greater than or equal to a third threshold, the confidence level (i.e., reliability) of the second category to which the traffic object belongs is high. Accordingly, when the largest confidence level corresponding to the second category to which the traffic object belongs in the plurality of frames of image is less than the third threshold value, the confidence level (i.e., reliability) of the second category to which the traffic object belongs is low. As shown in FIG. 4, the largest confidence level corresponding to the second category to which the traffic object belongs in the 60th frame (Frame60) of image is 100%, which is considered as high reliability. The largest confidence level corresponding to the second category to which the traffic object belongs in the 21st frame (Frame 21) of image is 80%, the largest confidence level corresponding to the second category to which the traffic object belongs in the 51st frame (Frame 51) of image is 40%, and the largest confidence level corresponding to the second category to which the traffic object belongs in the 55th frame (Frame 55) image is 50%, all of which can be considered as low reliability.

It is noted that the third threshold value may be determined according to the actual situation. As an embodiment, the third threshold value may be determined according to the largest confidence level corresponding to all frames of image. For example, in 100 frames of image, a proportion of images having the largest confidence level of 100% is 80%, a proportion of images having the largest confidence level of 80% is 15%, and a proportion of images having the largest confidence level of 50% is 5%. In this case, a classification result of the images may be considered to be reliable, and the third threshold value may be set to be high, for example, 90% or even 95%. Accordingly, if a calculation result of the largest confidence level in the image is not high, the third threshold value may be set to be small, which is not limited in the embodiment.

In the embodiment, the electronic device determines correction information of the fine classification category of the traffic object of the first category, the largest confidence level of which does not meet the preset condition based on a comparison result of the confidence levels of the fine classification categories with the largest confidence level of the traffic object of the first category in the plurality of frames of image, and the fine classification category of the traffic object of the first category, the largest confidence level of which does not meet the preset condition, is corrected, thereby improving a classification accuracy of the traffic object in the video stream, and providing a reliable basis for downstream decision control.

In some optional embodiments of the disclosure, the operation that the correction information of the fine classification category of the traffic object of the first category the largest confidence level of which does not meet the preset condition is determined based on the comparison result of the confidence levels of the fine classification categories with the largest confidence level of the traffic object of the first category in the plurality of frames of image includes: setting the fine classification category with the largest confidence level of the traffic object of the first category in the second image to be the same as the fine classification category with the largest confidence level of the traffic object of the first category in the first image, when a confidence level of the fine classification category with the largest confidence level of the traffic object of the first category in a first image in the plurality of frames of image meets a third preset condition and a confidence level of the fine classification category with the largest confidence level of the traffic object of the first category in a second image in the plurality of frames of image does not meet the third preset condition.

Exemplarily, the confidence level may meet the third preset condition in a case that the confidence level is greater than or equal to a fourth threshold.

In the embodiment, an order of the first image and the second image in the plurality of frames of image is not limited, that is, the first image is arranged after the second image, or the first image is arranged prior to the second image.

In some optional embodiments, the second image is one frame of image after the first image. The present embodiment is applicable to a scenario in which real-time detection is performed on the image.

Exemplarily, the confidence level meeting a third preset condition may indicate a high degree of reliability or high reliability. Accordingly, the confidence level not meeting the third preset condition may indicate a low degree of reliability or low reliability. For the traffic objects of the same category (first category), if the confidence level of the largest second category (i.e. the fine classification category) of the traffic objects in the first image is high (the confidence level meets the third preset condition) and the confidence level of the largest second category (i.e. the fine classification category) of the traffic objects in the second image is low (the confidence level does not meet the third preset condition), the fine classification result with high reliability (i.e. the largest second category) in the first image may be used to replace the fine classification result with low reliability (i.e. the largest second category) in the second image.

The above-described embodiments are applied for real-time detection classification processes of images, such as an inaccurate classification result of a subsequent image due to occlusion. For example, Table 1 schematically shows a classification before correction, and Table 2 schematically shows the classification after correction. Referring to Table 1, real-time detection and classification are performed on five frames of image, to obtain four traffic objects with identifier IDs 1, 2, 3 and 4 respectively (the traffic objects of the first two frames of image are the same traffic object, and thus have the same ID), the first category and the second category of each traffic object, and the corresponding confidence levels. When it is determined that the four traffic objects are the same traffic object by tracking the traffic objects, the four traffic objects are associated with the same identifier ID 1, and the fine classification result with high reliability is used to replace the fine classification result with low reliability. As shown in Table 2, all the fine classification results with low reliability are replaced with the fine classification result with high reliability, in which, the first category is speed, the second category is 50, and the confidence level is high.

TABLE 1

| Identifier ID | 1 | 1 | 2 | 3 | 4 |
|---|---|---|---|---|---|
| First | speed | speed | prohibition | speed | speed |
| Category | | | | | |
| Second | 50 | 50 | Forbidden to | 30 | 50 |
| Category | | | pass | | |
| Confidence | high | high | low | low | high |
| level | | | | | |

TABLE 2

| Identifier ID | 1 | 1 | 1 | 1 | 1 |
|---|---|---|---|---|---|
| First Category | speed | speed | speed | speed | speed |
| Second | 50 | 50 | 50 | 50 | 50 |
| Category | | | | | |
| Confidence | high | high | — | high | high |
| level | | | | | |

In the embodiment, the fine classification category of the traffic object of the first category, the largest confidence level of which does not meet the preset condition, is corrected by correcting the fine classification result (the fine classification category with the largest confidence level) of the same traffic object with low reliability using the fine classification result with the high reliability, which can provide sufficient basis for the downstream module (such as the control module, the decision module, etc.), and facilitate subsequent real-time control.

In other optional embodiments, the first image is one frame of image after the second image. The present embodiment is applicable to a scenario in which training data is classified incorrectly.

In the embodiment, the above-described images (including the first image and the second image) and the classification result are used for training the network model. In a case that a classification is incorrect due to a long distance, such as the scenario shown in FIG. 1, the recognized fine classification result of the 21st frame (Frame21) of image has low reliability (or low confidence level) due to the long distance. As getting closer to the traffic object, the collected images become clear, and the reliability of the fine classification result changes. For example, the classification result of Frame 60 is at high reliability (or high confidence level). In order to optimize the training data, the fine classification result of the previous second image at low reliability may be replaced with the fine classification result of the subsequent first image at high reliability.

For example, Table 3 schematically shows the classification before correction, and Table 4 schematically shows the classification after correction. Referring to Table 3, real-time detection and classification are performed on five frames of image, to obtain four traffic objects with identifier IDs 1, 2, 3 and 4 respectively (where the traffic objects of the first two frames of image are the same traffic object, and thus have the same ID), the first category and the second category of each traffic object, and the confidence levels thereof. When it is determined that the four traffic objects are the same traffic object by tracking the traffic objects, the four traffic objects are associated with the same identifier ID 1, as shown in Table 4. For traffic objects of the same category (first category), since the reliability of the fine classification results of the previous frames of image is low (which does not meet the third preset condition) and the reliability of the fine classification result of the same traffic object in the fifth frame of image is high (which meets the third preset condition), all the fine classification results with low reliability corresponding to the previous frames of image are replaced with fine classification results with high reliability, and the fine classification result for replacing includes that the first category is speed, the second category is 50, and the confidence level is high.

TABLE 3

| Identifier ID | 1 | 1 | 2 | 3 | 4 |
|---|---|---|---|---|---|
| First category | prohibition | speed | speed | speed | speed |
| Second | speed | 30 | 30 | 60 | 50 |
| category | | | | | |
| Confidence | low | low | low | low | high |
| level | | | | | |

TABLE 4

| Identifier ID | 1 | 1 | 1 | 1 | 1 |
|---|---|---|---|---|---|
| First category | speed | speed | speed | speed | speed |
| Second | 50 | 50 | 50 | 50 | 50 |
| category | | | | | |
| Confidence | high | high | high | high | high |
| level | | | | | |

In some optional embodiments of the present disclosure, the operation that the correction information of the fine classification category of the traffic object of the first category, the largest confidence level of which does not meet the preset condition, are determined based on the comparison result of the confidence levels of the fine classification categories with the largest confidence level of the traffic object of the first category in the plurality of frames of image may further include: outputting prompt information indicating that a classification result of the traffic object cannot be determined in response to the confidence levels of the fine classification categories with the largest confidence level of the traffic object of the first category in the plurality of frames of image all do not meet a third preset condition.

In the embodiment, if the confidence level of the fine classification category with the largest confidence level of the traffic object of the first category in each frame of the plurality of frames of image does not meet the third preset condition, that is, the confidence levels of the fine classification category with the largest confidence level of the traffic object of the first category in each frame of image is less than a fourth threshold value, that is, the reliability of the fine classification category with the largest confidence level of the traffic object of the first category in each frame of image is low, the fine classification category of the traffic object of the first category cannot be determined, and prompt information indicating that the classification result cannot be determined is outputted.

For example, with reference to the classification results in the aforementioned Table 3, real-time detection and classification are performed on five frames of image, to obtain four traffic objects with identifier IDs 1, 2, 3, and 4, respectively (where the traffic objects of the first two images are the same traffic object, and thus have the same ID), the first category and the second category of each traffic object, and the confidence levels corresponding to the first category and the second category. When it is determined that the four traffic objects are the same traffic object by tracking the traffic objects, the four traffic objects are associated with the same identifier ID 1, as shown in Table 5. It is assumed that the fourth frame of image is currently acquired, since the classification results of the second category corresponding to the same traffic object in the first three frames of image all have low confidence level, and the classification result of the second category corresponding to the same traffic object in the fourth frame of image still has low confidence level (the third preset condition is not met), prompt information indicating that the classification result cannot be determined is outputted. In some embodiments, when the fifth frame of image is acquired and it is detected that the classification result of the second category corresponding to the same traffic object in the fifth frame of image has high confidence level (the third preset condition is met), the classification result of the high confidence level, that is, the fine classification result “the speed of 50 km/h”, may be outputted.

TABLE 5

| Identifier ID | 1 | 1 | 2 | 3 | 4 |
|---|---|---|---|---|---|
| First category | ? ? | ? ? | ? ? | ? ? | speed |
| Second | ? ? | ? ? | ? ? | ? ? | 50 |
| category | | | | | |
| Confidence | ? ? | ? ? | ? ? | ? ? | high |
| level | | | | | |

Based on the above-described method embodiment, the embodiment of the present disclosure further provides a device for image processing. FIG. 5 is a schematic diagram of a composition structure of a device for image processing according to an embodiment of the present disclosure. As shown in FIG. 5, the device includes: an acquisition unit 21, a first determination unit 22, a second determination unit 23, and a third determination unit 24.

The acquisition unit 21 is configured to acquire a video stream captured by an image capturing device installed on a traveling device.

The first determination unit 22 is configured to determine a plurality of frames of image containing a specific traffic object from the video stream.

The second determination unit 23 is configured to determine a category of a specific traffic object and a confidence level of the category in each of the plurality of frames of image.

The third determination unit 24 is configured to determine correction information of the category, a confidence level of which does not meet a preset condition, based on a comparison result of the confidence levels of the categories of the specific traffic object in the plurality of frames of image.

In some optional embodiments of the present disclosure, the first determining unit 22 configured to determine first regions of traffic objects in images containing the traffic objects in the video stream; determine a second region within the first region for each first region, the second region being smaller than the first region; select an image containing a traffic object of a first category from the images containing the traffic object based on information about each of the second regions, and taking a plurality of frames of image containing the traffic object of the first category as the plurality of frames of image containing the specific traffic object, the first category is a category to which the specific traffic object belongs.

In some optional embodiments of the present disclosure, the second region is a central region of the first region, and the information about the second region is information about a central region of a feature map of the first region.

In some optional embodiments of the present disclosure, the first determination unit 22 is configured to perform feature extraction on each of the second regions, and determining a first similarity of pixels in each of the second regions based on the extracted features; determine an image in which the second region in which position information meets a first preset condition and the first similarity meets a second preset condition is located as an image containing the traffic object of the first category.

In some optional embodiments of the present disclosure, the second determination unit 23 is configured to determine a fine classification category with the largest confidence level of a traffic object of the first category and a confidence level of the fine classification category in each of the plurality of frames of image, the first category being a category to which the specific traffic object belongs.

In some optional embodiments of the present disclosure, the third determination unit 24 is configured to determine correction information of a fine classification category of the traffic object of the first category, the largest confidence level of which does not meet the preset condition, based on a comparison result of the confidence levels of the fine classification categories with the largest confidence level of the traffic object of the first category in the plurality of frames of image.

In some optional embodiments of the present disclosure, the second determination unit 23 is configured to determine a second similarity between a traffic object of the first category and a template image of each of the second categories in each of the plurality of frames of image, each of the second category being a fine classification category of the first category; determine a fine classification category with the largest a confidence level of the traffic object of the first category and a confidence level of the fine classification category in each frame of the image based on the second similarity.

In some optional embodiments of the present disclosure, the third determination unit 24 is configured to set the fine classification category with the largest confidence level of the traffic object of the first category in the second image to be the same as the fine classification category with the largest confidence level of the traffic object of the first category in the first image, in a case that a confidence level of the fine classification category with the largest confidence level of the traffic object of the first category in a first image in the plurality of frames of image meets a third preset condition and a confidence level of the fine classification category with the largest confidence level of the traffic object of the first category in a second image in the plurality of frames of image does not meet the third preset condition.

In some optional embodiments of the present disclosure, the third determination unit 24 is configured to output prompt information indicating that a classification result of the traffic object cannot be determined, in response to the confidence levels of the fine classification categories with the largest confidence level of the traffic object of the first category in the plurality of frames of image all do not meet a third preset condition.

In the embodiment of the present disclosure, the acquisition unit 21, the first determination unit 22, the second determination unit 23, and the third determination unit 24 in the device can be implemented by a Central Processing Unit (CPU), a Digital Signal Processor (DSP), a micro control unit (MCU), or a Programmable Gate Array (FPGA) in practical applications.

It should be noted that when the device for image processing provided by the above-mentioned embodiments is divided into for example the above program modules when performing image processing. In practical application, the above-mentioned processing may be distributed into different program modules according to needs, that is, an internal structure of the device can be divided into different program modules to implement all or a part of the processing described above In addition, the device for image processing and the method for image processing provided by the above-mentioned embodiments belong to the same conception, and regarding the specific implementation process of the device, reference may be made to the method embodiment, which is not be described here in detail.

The embodiment of the present disclosure further provides an electronic device.

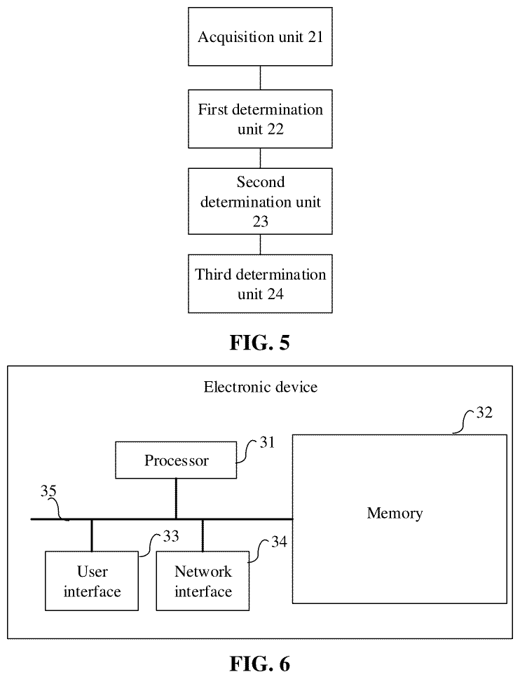

FIG. 6 is a schematic diagram of a hardware composition structure of the electronic device according to an embodiment of the present disclosure. As shown in FIG. 6, the electronic device includes a memory 32, a processor 31, and a computer program stored in the memory 32 and executable on the processor 31. When the processor 31 executes the program, the processor implements the operations of the method for image processing according to the embodiment of the present disclosure.

Optionally, the electronic device may further include a user interface 33 and a network interface 34. The user interface 33 may include a display, a keyboard, a mouse, a trackball, a click wheel, a key, a button, a tactile pad, a touch screen, or the like.

Alternatively, the various components in the electronic device are coupled together by a bus system 35. It will be appreciated that the bus system 35 is used to implement connection communication between these components. The bus system 35 includes a power bus, a control bus, and a status signal bus in addition to a data bus. However, for the sake of clarity of illustration, the various buses are labeled as bus system 35 in FIG. 6.

It can be appreciated that the memory 32 may be a volatile memory or a non-volatile memory, and may include both the volatile memory and the non-volatile memory. The non-volatile memory may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a ferromagnetic surface memory, a compact disc, or a compact disc read-only memory (CD-ROM). The ferromagnetic surface memory may be a disk memory or a tape memory. The volatile memory may be a random access memory (RAM), which serves as an external cache. By way of exemplary but not limiting illustration, many forms of RAM are available, such as static random access memory (SRAM), synchronous static random access memory (SSRAM), dynamic random access memory (DRAM), synchronous dynamic random access memory (SDRAM), double data rate synchronous dynamic random access memory (DDRSDRAM), enhanced synchronous dynamic random access memory (ESDRAM), synclink dynamic random access memory (SLDRAM), direct rambus random access memory (DRRAM). Memories 32 described in embodiments of the present disclosure are intended to include but are not limited to these and any other suitable types of memories.

The methods disclosed above in embodiments of the present disclosure may be [00104] applied to or implemented by the processor 31. The processor 31 may be an integrated circuit chip having signal processing capability. In implementation, the operations of the method described above may be implemented by integrated logic circuits of the hardware in the processor 31 or by instructions in the form of software. The processor 31 may be a general purpose processor, a DSP, or other programmable logic devices, a discrete gate or a transistor logic device, a discrete hardware component or the like. The processor 31 may implement or execute the disclosed methods, operations and logical block diagrams in embodiments of the present disclosure. The general-purpose processor may be a microprocessor or any conventional processor or the like. The operations of the method disclosed in conjunction with the embodiments of the present disclosure can be directly executed and implemented by a hardware decoding processor, or by combining hardware and software modules in the decoding processor. The software module may be located in a storage medium in a memory 32, and the processor 31 reads information in the memory 32 and implement the operations of the foregoing method in conjunction with its hardware.

In exemplary embodiments, the electronic device may be implemented by one or more application specific integrated circuits (ASICs), DSPs, programmable logic devices (PLDs), complex programmable logic devices (CPLDs), FPGAs, general purpose processors, controllers, MCUs, microprocessors, or other electronic components for performing the foregoing methods.

In exemplary embodiments, the embodiments of the present disclosure further provide a computer-readable storage medium, such as memory 32 including a computer program that may be executed by the processor 31 of the electronic device to implement the operations described in the foregoing method. The computer-readable storage medium may be a memory such as an FRAM, an ROM, a PROM, an EPROM, an EEPROM, a Flash Memory, a ferromagnetic surface memory, a compact disc, or a CD-ROM, and may also be a variety of devices including one or any combination of the above-mentioned memories.

The embodiment of the present disclosure further provides a computer-readable storage medium having stored thereon a computer program which, when executed by a processor, implements the operations of the method for image processing according to the embodiment of the present disclosure.

The embodiment of the present disclosure provides a computer program product including a non-transitory computer-readable storage medium storing a computer program which, when read and executed by a computer, implements a part or all of the operations of the method for image processing of the embodiment of the present disclosure.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several method or device embodiments provided in the present disclosure can be arbitrarily combined without conflict to obtain a new method or device embodiment.

In several embodiments provided in the present disclosure, it should be appreciated that the disclosed devices and methods may be implemented in other ways. The device embodiments described above are only schematic, for example, the division of the units is only a logical functional division, and may be actually implemented in other ways. For example, a plurality of units or components may be combined, or may be integrated into another system, or some features may be ignored, or not performed. In addition, coupling, or direct coupling, or a communication connection between the shown or discussed components may be indirect coupling or communication connection via some interface, device or unit, or may be electrical, mechanical, or otherwise.

The units described above as separate components may or may not be physically separated, and the components displayed as units may or may not be physical units. That is, the units may be located in the same place or may be distributed over a plurality of network elements. A part or all of these units may be selected according to actual needs to achieve the purpose of the present embodiment.

In addition, various functional units in each embodiment of the present disclosure may be all integrated into one processing unit, or various units may be each separated as one unit, or two or more units may be integrated into one unit. The integrated unit can be realized in the form of hardware or in the form of hardware and software function units.

A person of ordinary skill in the field may understand that all or part of the operations of implementing the above-mentioned method embodiment can be completed by instructing related hardware through a program, the above-mentioned program may be stored in a computer-readable storage medium. When the program is executed, the operations including the above-mentioned method embodiment are executed. The above storage medium includes a mobile storage device, a ROM, a RAM, a magnetic disk or an optical disk, and other media capable of storing program codes.

Alternatively, the integrated units of the disclosure may be stored in a computer-readable storage medium if the integrated units are implemented in the form of software functional modules and sold or used as a stand-alone product. Based on this understanding, an essential part of the technical solution of the embodiments of the present disclosure or parts of the technical solution that contribute to the prior art may be embodied in the form of a software product, and the computer software product is stored in a storage medium and includes a number of instructions for causing a computer device (which may be a personal computer, a server, a network device, etc.) to perform all or part of the methods described in the embodiments of the present disclosure. The storage medium includes a mobile storage device, a ROM, a RAM, a magnetic disk or an optical disk, and other media capable of storing program codes.

Only implementations of the present disclosure are described above, but the protection scope of the present disclosure is not limited thereto. Changes or substitutions easily conceived by any skilled person in the technical field fall within the protection scope of the present disclosure.

### INDUSTRIAL PRACTICALITY

Embodiments of the present disclosure disclose a method and a device for image processing, an electronic device, a storage medium, and a computer program product. The method includes the following operations. A video stream captured by an image capturing device installed on a traveling device is acquired, and a plurality of frames of image containing a specific traffic object is determined from the video stream. A category of the specific traffic object and a confidence level of the category in each of the plurality of frames of image are determined. Correction information of the category, the confidence level of which does not meet a preset condition, is determined based on a comparison result of the confidence levels of the categories of the specific traffic object in the plurality of frames of image. According to the technical solution of the embodiment of the present disclosure, the category, the confidence level of which does not meet the preset condition, is corrected according to the comparison result of the confidence levels of the categories of the specific traffic object in the plurality of frames of image, that is, a classification result with low reliability is corrected by using a classification result with high reliability of the specific traffic object, which can improve the classification accuracy of the traffic object in the image on the one hand, and can provide a reliable basis for downstream decision control on the other hand, thereby facilitating subsequent real-time control.

1. A method for image processing, comprising:
acquiring a video stream captured by an image capturing device installed on a traveling device, and determining a plurality of frames of image containing a specific traffic object from the video stream;
determining a category of the specific traffic object and a confidence level of the category in each frame of the plurality of frames of image; and
determining correction information of the category, the confidence level of which does not meet a preset condition, based on a comparison result of the confidence levels of the categories of the specific traffic object in the plurality of frames of image.

2. The method of claim 1, wherein the determining the plurality of frames of image containing the specific traffic object from the video stream comprises:
determining first regions of traffic objects in images containing the traffic objects in the video stream;
determining a second region within each of the first regions, the second region being smaller than the first region; and
selecting, based on information about each of the second regions, an image containing a traffic object of a first category from the images containing the traffic object to constitute the plurality of frames of image containing the specific traffic object, the first category being a category to which the specific traffic object belongs.

3. The method of claim 2, wherein the second region is a central region of the first region, and the information about the second region is information about a central region of a feature map of the first region.

4. The method of claim 2, wherein the selecting the image containing the traffic object of the first category from the images containing the traffic object based on the information about each of the second regions comprises:
extracting features of each of the second regions, and determining a first similarity of pixels in the respective second region based on the extracted features; and
determining an image where the second region is located as an image containing the traffic object of the first category, position information of the second region meeting a first preset condition, and the first similarity of the second region meeting a second preset condition.

5. The method of claim 1, wherein the determining the category of the specific traffic object and the confidence level of the category in each of the plurality of frames of image comprises:
determining, in each of the plurality of frames of image, a fine classification category with a largest confidence level of a traffic object of a first category and a confidence level of the fine classification category, the first category being a category to which the specific traffic object belongs.

6. The method of claim 5, wherein the determining the correction information of the category the confidence level of which does not meet the preset condition based on the comparison result of the confidence levels of the categories of the specific traffic object in the plurality of frames of image comprises: determining correction information of a fine classification category of the traffic object of the first category, the largest confidence level of which does not meet the preset condition, based on a comparison result of the confidence levels of the fine classification categories with the largest confidence level of the traffic object of the first category in the plurality of frames of image.

7. The method of claim 5, wherein the determining in each of the plurality of frames of image the fine classification category with the largest confidence level of the traffic object of the first category and the confidence level of the fine classification category comprises:
determining, in each of the plurality of frames of image, a second similarity between the traffic object of the first category and a template image of each of second categories, each of the second category being a fine classification category of the first category; and
determining, in each of the plurality of frames of image, a fine classification category with the largest confidence level of the traffic object of the first category and a confidence level of the fine classification category based on the second similarity.

8. The method of claim 6, wherein the determining correction information of a fine classification category of the traffic object of the first category the largest confidence level of which does not meet the preset condition based on a comparison result of the confidence levels of the fine classification categories with the largest confidence level of the traffic object of the first category in the plurality of frames of image comprises:
setting the fine classification category with the largest confidence level of the traffic object of the first category in a second image in the plurality of frames of image to be a same category as the fine classification category with the largest confidence level of the traffic object of the first category in a first image in the plurality of frames of image, in a case that a confidence level of the fine classification category with the largest confidence level of the traffic object of the first category in the first image meets a third preset condition, and a confidence level of the fine classification category with the largest confidence level of the traffic object of the first category in the second image does not meet the third preset condition.

9. The method of claim 8, further comprising:
outputting prompt information indicating that it is unable to determine a classification result of the traffic object in a case that the confidence levels of the fine classification categories with the largest confidence level of the traffic object of the first category in the plurality of frames of image do not meet a third preset condition.

10. A device for image processing, comprising:
a memory;
a processor; and
a computer program stored on the memory and executable on the processor, wherein the processor is configured to execute the computer program to:
acquire a video stream captured by an image capturing device installed on a traveling device;
determine a plurality of frames of image containing a specific traffic object from the video stream;
determine a category of a specific traffic object and a confidence level of the category in each frame of the plurality of frames of image; and
determine correction information of the category, the confidence level of which does not meet a preset condition, based on a comparison result of the confidence levels of the categories of the specific traffic object in the plurality of frames of image.

11. The device of claim 10, wherein the processor is configured to execute the computer program to:
determine first regions of traffic objects in images containing the traffic objects in the video stream;
determine a second region within each of the first regions, the second region being smaller than the first region; and
select, based on information about each of the second regions, an image containing a traffic object of a first category from the images containing the traffic object to constitute the plurality of frames of image containing the specific traffic object, the first category being a category to which the specific traffic object belongs.

12. The device of claim 11, wherein the second region is a central region of the first region, and the information about the second region is information about a central region of a feature map of the first region.

13. The device of claim 11, wherein the processor is configured to execute the computer program to:
extract features of each of the second regions, and determine a first similarity of pixels in the respective second region based on the extracted features; and
determine an image where the second region is located as an image containing the traffic object of the first category, position information of the second region meeting a first preset condition, and the first similarity of the second region meeting a second preset condition.

14. The device of claim 10, wherein the processor is configured to execute the computer program to:
determine, in each of the plurality of frames of image, a fine classification category with a largest confidence level of a traffic object of a first category and a confidence level of the fine classification category, the first category being a category to which the specific traffic object belongs.

15. The device of claim 14, wherein the processor is configured to execute the computer program to: determine correction information of a fine classification category of the traffic object of the first category, the largest confidence level of which does not meet the preset condition, based on a comparison result of the confidence levels of the fine classification categories with the largest confidence level of the traffic object of the first category in the plurality of frames of image.

16. The device of claim 14, wherein the processor is configured to execute the computer program to:
determine, in each of the plurality of frames of image, a second similarity between the traffic object of the first category and a template image of each of second categories, each of the second category being a fine classification category of the first category; and
determine, in each frame of the image, a fine classification category with the largest confidence level of the traffic object of the first category and a confidence level of the fine classification category based on the second similarity.

17. The device of claim 15, wherein the processor is configured to execute the computer program to:
set the fine classification category with the largest confidence level of the traffic object of the first category in a second image in the plurality of frames of image to be a same category as the fine classification category with the largest confidence level of the traffic object of the first category in a first image in the plurality of frames of image, in a case that a confidence level of the fine classification category with the largest confidence level of the traffic object of the first category in the first image meets a third preset condition, and a confidence level of the fine classification category with the largest confidence level of the traffic object of the first category in the second image does not meet the third preset condition.

18. The device of claim 17, wherein the processor is configured to execute the computer program to
output prompt information indicating that it is unable to determine a classification result of the traffic object in a case that the confidence levels of the fine classification categories with the largest confidence level of the traffic object of the first category in the plurality of frames of image do not meet a third preset condition.

19. A non-transitory computer-readable storage medium having stored thereon a computer program which, when executed by a processor, implements:
acquiring a video stream captured by an image capturing device installed on a traveling device, and determining a plurality of frames of image containing a specific traffic object from the video stream;
determining a category of the specific traffic object and a confidence level of the category in each frame of the plurality of frames of image; and
determining correction information of the category, the confidence level of which does not meet a preset condition, based on a comparison result of the confidence levels of the categories of the specific traffic object in the plurality of frames of image.

20. The non-transitory computer-readable storage medium of claim 19, wherein the computer program, when executed by the processor, implements:
determining first regions of traffic objects in images containing the traffic objects in the video stream;
determining a second region within each of the first regions, the second region being smaller than the first region; and
selecting, based on information about each of the second regions, an image containing a traffic object of a first category from the images containing the traffic object to constitute the plurality of frames of image containing the specific traffic object, the first category being a category to which the specific traffic object belongs.
